(19) United States
(12) Patent Application Publication
(10) Pub. No.: US 2026/0251526 A1
(43) Pub. Date: Aug. 27, 2026

(54) SYSTEM AND METHOD FOR MONITORING AVAILABLE LOAD CAPACITY OF TOWERS

(71) Applicant: SAUDI ARABIAN OIL COMPANY, Dhahran (SA)

(72) Inventors: Abdullah M. MEDAWI, Dhahran (SA); Ayed A. RUWAILI, Dhahran (SA)

(73) Assignee: SAUDI ARABIAN OIL COMPANY, Dhahran (SA)

(21) Appl. No.: 19/062,645

(22) Filed: Feb. 25, 2025

(51) Int. Cl. G01M 5/00; G01P 5/02

(52) U.S. Cl. CPC G01M 5/0025; G01P 5/02

(57) ABSTRACT

A tower load system includes a meta node, a position node, an anemometer, a displacement sensor, one or more load cells, and a computer system. The meta node stores mechanical information of equipment mounted on a tower. The position node stores position information of the equipment. The anemometer measures wind speed and direction. The displacement sensor determines a displacement of the tower relative to a first position. The one or more load cells each measure a load. The computer system includes a computer readable medium having instructions stored, that when executed, performs a method. The method includes performing a tower load analysis based on the mechanical and position information of the equipment, the wind speed, the displacement of the tower, and the load, and determining an available load capacity on the tower for additional equipment to be mounted to the tower based on the tower load analysis.

### FIELD OF THE DISCLOSURE

The present disclosure relates generally to the structural capacity of towers and, more particularly, to a system and method for performing a tower load analysis.

### BACKGROUND OF THE DISCLOSURE

Telecommunications towers have a limited load capacity to support a variety of telecommunications equipment. However, there is not a robust inventory management system for telecommunications towers, which results in the inability to monitor a tower's remaining load capacity to handle additional telecommunications equipment. As a result, telecommunications towers frequently become overloaded with equipment, such as antennas and appurtenances from multiple telecommunications companies when one or more telecommunications companies try to meet growing market demand by adding additional telecommunications equipment to existing telecommunications towers. Additionally, equipment on these towers may go inactive over time but remain on the tower for a prolonged period, leading to inefficient tower utilization. Additionally, the lack of a robust inventory management of the equipment on the towers makes it difficult to identify which towers in a network of towers have available load capacity.

Further, engineering standards mandate performing a tower load analysis (TLA) in some jurisdictions before installing any additional equipment on these towers to ensure that the additional equipment will not put the tower at risk of collapse. However, operators frequently face challenges in conducting accurate TLAs due to the presence of equipment from various operators and the absence of a system and method to accurately reflect changes in a tower's equipment inventory and update the TLA accordingly. Additionally, TLAs require time and costs associated with qualified engineering personnel.

Thus, there is a need in the art for a tower system that can monitor the available load capacity of existing telecommunications towers to identify which towers can accommodate additional telecommunications equipment. Additionally, there is a need in the art for a cheaper and quicker alternative to performing a TLA to ascertain if adding the additional equipment to the tower is a viable option.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a tower load system comprises a meta node, a position node, an anemometer, a displacement sensor, one or more load cells, and a computer system. The meta node having mechanical information of pieces of equipment mounted on a tower stored thereon, the tower being formed from one or more tower members. The position node having position information of the pieces of equipment stored thereon. The anemometer is positioned on the tower and is configured to measure wind speed and direction. The displacement sensor configured to determine a displacement of the tower relative to a first position. The one or more load cells are coupled to the tower, wherein each of the one or more load cells measures a load. The computer system includes a computer readable medium having instructions stored thereon, that when executed, cause a first method to be performed. The method comprises performing a TLA based on the mechanical information of the pieces of equipment, the position of the pieces of the equipment, the measured wind speed, the displacement of the tower, and the load measured by each of the one or more load cells. The method further comprises determining an available load capacity on the tower for additional pieces of equipment to be mounted to the tower based on the TLA.

In another embodiment, consistent with the present disclosure, a method of performing a TLA comprises collecting wind data from an anemometer mounted on a tower. The method further comprises identifying the weight and position of one or more pieces of telecom equipment mounted on the tower. The method further comprises measuring a displacement of the tower using a displacement sensor mounted to the tower. The method further comprises collecting load data from one or more load cells mounted to the tower. The method further comprises performing a TLA based on the weight and position of each piece of telecom equipment, the collected wind data, the measured displacement, and the load measured by each of the one or more load cells. The method further comprises determining an available load capacity on the tower for additional pieces of telecom equipment to be mounted to the tower based on the TLA.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic view of an example tower system in accordance with aspects of the present disclosure.

FIG. 2 is a flowchart illustrating an example method of performing a tower load analysis.

FIG. 3 is a flowchart illustrating an example method of periodically monitoring a tower.

FIG. 4 is a block diagram of a nonlimiting example computer system that can be employed to execute one or more elements of the procedures described herein in accordance with embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to a tower load system for modeling a tower and determining if the tower has any remaining load capacity to accommodate additional equipment. Additionally, the tower load system can identify inactive equipment on the tower. This inactive equipment may be removed so that the additional equipment can be added, and the load capacity of the tower is used efficiently. The tower system can also perform a tower load analysis (TLA) to model if a proposed placement of the additional equipment on the tower will be within acceptable design and/or regulatory thresholds. Additionally, the tower load system can use real time data inputs from equipment and/or sensors on the tower to monitor the structural integrity of the tower. For example, the tower load system may identify if the tower has become overloaded, has an undesirable tilt, or if one or more members forming the tower is showing signs of failure. The tower load system, therefore, may reduce the time and costs associated with completing engineering assessments of the tower and may decrease the time necessary to identify towers that can accommodate additional pieces of equipment.

The presently disclosed tower load system may prove advantageous for at least a couple of reasons. For example, one or more load cells of the tower load system for determining available load capacity of the tower help understand how the load from different pieces of equipment affect the tower. Additionally, the tower load system can provide real time monitoring of the tower which allows for early detection and mitigation of potential loading or structural issues with the tower. Additionally, the tower load system will decrease the time and costs that come from engineering assessments of towers and decrease the time necessary to identify towers with available load capacity.

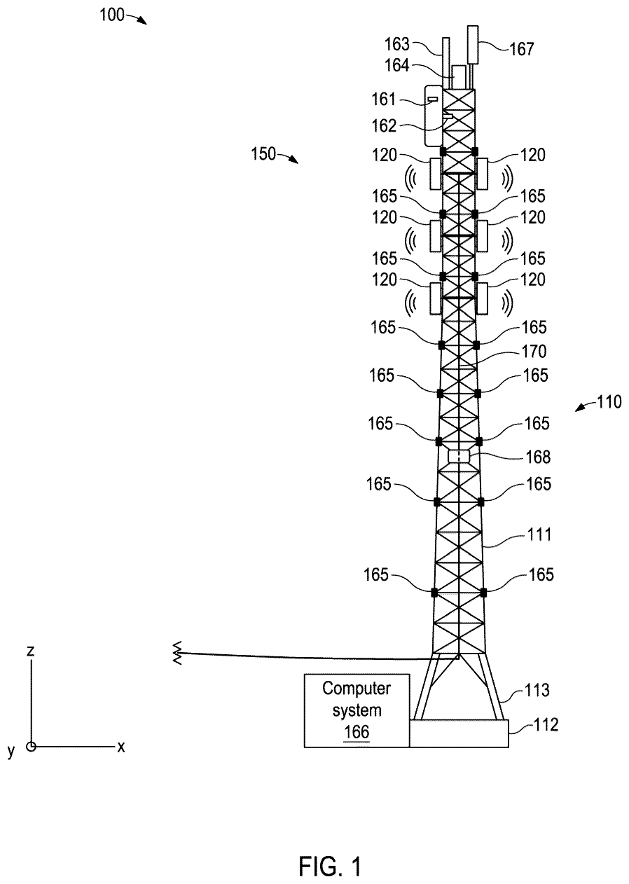

FIG. 1 illustrates a schematic view of an example tower system 100. The tower system 100 includes a tower 110 and a tower load system 150 that is operatively coupled to the tower 110. The tower load system 150 is used to track what equipment 120 is mounted on the tower 110, track the operational status of the equipment 120 on (mounted to) the tower 110, and to perform a TLA of the tower 110. The TLA performed by the tower load system 150 may be used to monitor the tower 110 in real time.

The tower 110 is illustrated as a telecommunication tower, such as a cell tower, that has the equipment 120 mounted thereon. The tower 110 is formed from one or more tower members 111. In some embodiments, the tower 110 may be a lattice tower, a monopole tower, or a guyed tower. FIG. 1 shows the tower 110 as a lattice tower formed from a plurality of tower members 111 that are supported above a base 112, such as the ground or a concrete foundation, by a plurality of legs 113.

Various pieces of equipment 120 may be mounted on the tower 110. The pieces of equipment 120 may be telecommunications equipment, such as antennas, microwave dishes, diplexers, amplifiers, or the like. The pieces of equipment 120 may also include appurtenances or accessories to other pieces of equipment 120, such as tilting mechanisms that can change the position of the antennas. The pieces of equipment 120 may be installed by the owner of the tower 110 or may be installed by one or more telecommunications operators, such as cellular companies (e.g., carriers), who acquire rights to utilize the tower 110.

The tower load system 150 includes a meta node 161, a position node 162, an anemometer 163, a displacement sensor 164, one or more load cells 165, and a computer system 166. In some embodiments, and as shown in FIG. 1, the meta node 161, the position node 162, the anemometer 163, the displacement sensor 164, and the one or more load cells 165 are mounted to the tower 110. In some embodiments, the meta node 161 and the position node 162 are not mounted to the tower 110. For example, the meta node 161 and the position node 162 may be stored on the computer system 166 or in a facility located at the tower site.

In some embodiments, the tower load system 150 may also include a health sensor 167 to monitor the operational health of a piece of equipment 120. For example, the health sensor 167 may be configured to monitor the health and performance of an aviation light, which may be one of the pieces of equipment 120 mounted to the tower 110. For example, the health sensor 167 may be configured to detect an intensity or brightness of the aviation light to identify if the aviation light is failing and needs a new light source (e.g., bulb) installed. In some embodiments, the tower load system 150 may also include one or more status sensors 168 configured to monitor the operational status (e.g., active, inactive) of some or all of the equipment 120. In some embodiments, the one or more status sensors 168 may include electromagnetic sensors operable to monitor power consumption or other operational characteristics of the equipment 120 as described in greater detail below.

The meta node 161 has mechanical information of the pieces of equipment 120 mounted on the tower 110 stored thereon. The meta node 161, may be, for example, a read-only memory (ROM) device with the mechanical information of the pieces of equipment 120 presently mounted on the tower 110 stored thereon. In some embodiments, the mechanical information includes the weight, dimensions, center of gravity, means of coupling to the tower 110, etc. of each piece of equipment 120. In some embodiments, the mass of each individual piece of equipment 120 is stored on the meta node 161 instead of or in addition to the weight.

The position node 162 includes the position information of each piece of equipment 120 stored thereon. In some embodiments, the position information includes the X, Y, and Z coordinates of the pieces of equipment 120 on the tower 110. The position information, for example, may be the height along the tower 110 (e.g., position in the Z-direction) at which the piece of equipment 120 is mounted. The position node 162 may be a ROM device mounted to the tower 110 that has the position information of the equipment 120 presently mounted to the tower 110 stored thereon. The weight (e.g., mass) and position of each piece of equipment 120 contributes to the load experienced by the tower 110.

The anemometer 163 is positioned on the tower 110, such as being positioned near the top of the tower 110 as shown in FIG. 1. The anemometer 163 is configured to measure wind speed and direction which is used to account for the wind load experienced by the tower 110. In some embodiments, multiple anemometers 163 may be disposed at various Z-positions (e.g., heights) along the tower 110.

The displacement sensor 164 is configured to determine a displacement (e.g., tilt) of the tower 110 relative to a first position. The first position may be the normal vertical position of the tower 110 shown in FIG. 1, where the central axis of the tower 110 extends directly along the Z-direction. The tower 110, however, may become displaced from the first position, such as by tilting due to the load exerted on the tower 110 by the pieces of equipment 120 and/or the load applied by the wind. For example, the tower 110 may sway in response to the wind. The sway may be exacerbated due to the weight of the equipment 120 mounted to the tower 110. In some instances, the tower 110 may tilt over time due to the base 112 settling. The tilt of the tower 110 influences the load experienced by the one or more tower members 111 due to the moment caused by the weight of the tower 110 (e.g., weight of the tower members 111 and equipment 120 mounted thereon). A tilt beyond an acceptable design threshold can result in the tower 110 falling over.

The one or more load cells 165 coupled to the tower 110 measure the tower load. In some embodiments, the load cells 165 may be coupled to one or more of the tower members 111. For example, the load cells 165 may be strain gauges connected to one or more of the tower members 111 to measure the strain which is then converted to the load (e.g., by the computer system 166). In some embodiments, the load cells 165 may be placed on the legs 113 to measure the tower load, such as being weight sensors placed under the feet of the legs 113. In some embodiments, the load cells 165 may be placed on a plurality of tower members 111, the joints between tower members 111, and one or more legs 113. The load cells 165 are used to measure the load being experienced by the tower 110, such as the localized load being experienced at the location of the load cell 165. This load includes the load exerted by the equipment mounted on the tower 110, such as the load exerted by the pieces of equipment 120 and components of the tower load system 150 (e.g., the meta node 161, the position node 162, the anemometer 163, the displacement sensor 164, the one or more load cells 165, the health sensor 167, and the one or more status sensors 168). The load experienced by the tower 110 is also influenced by the tower displacement (e.g., tilt) and the force applied by the wind.

One or more pieces of the equipment 120 may no longer be in active service. For example, some of the equipment 120 may have failed. As another example, some of the equipment 120 may have fallen into disuse, such as falling out of active service due to lack of demand, becoming outdated, or due to becoming forgotten about by the one or more telecommunications companies using the equipment 120 on the tower 110. Inactive equipment 120 takes up a portion of the load capacity of the tower 110, and having inactive equipment 120 on the tower 110 is an inefficient use of the tower load capacity since the inactive equipment 120 is not performing a desirable function. The one or more status sensors 168 are configured to detect whether one or more pieces of the equipment 120 on the tower 110 are active or inactive. The one or more status sensors 168 may be electromagnetic sensors coupled to a cable 170 (e.g., hex cable) leading to one or more pieces of equipment 120 mounted on the tower 110. The one or more status sensors 168, for example, can determine (or produce a signal from which it may be determined) if a piece of equipment 120 is inactive by evaluating the power consumption of the equipment 120 and/or the signals sent to and from the equipment 120 through the cable 170. In some embodiments, there may be separate status sensors 168 for each piece or cluster of equipment 120. The inactive equipment 120, once identified, can be brought back into service or removed to make room for the additional equipment 120.

One or more pieces of the equipment 120 may no longer be in active service but are on standby by the one or more telecommunications companies. For example, some of the equipment 120 may serve as back up equipment for the one or more telecommunications companies in case of emergencies or failure of other equipment 120, only becoming active when the emergency or failure of the other equipment 120 occurs. As another example, some of the equipment 120 may only be used during peak hours when communications traffic is high and then returns to a standby mode (e.g., appears inactive) outside of peak-hours. The information from the one or more status sensors 168 may be indexed with the function of one or more pieces of the equipment 120, such as being indexed to the function performed by the equipment stored on the meta node 161, to determine if the one or more pieces of the equipment 120 are actually inactive (e.g., not providing a desirable function on the tower) or is instead on standby or a backup for a different piece of equipment.

The computer system 166 is in communication with the other components of the tower load system 150, such as the meta node 161, the position node 162, the anemometer 163, the displacement sensor 164, the one or more load cells 165, the health sensor 167, and the one or more status sensors 168 shown in FIG. 1. The computer system 166 may be in communication with the other components of the tower load system 150 via a wired or wireless connection, such as being connected by one or more wireless transceivers. The computer system 166 may be remote to the tower 110, such as being located at a network operations center (NOC), or located at the tower site in a building or other structure located adjacent to the tower 110.

The computer system 166 uses the tower's structural information (e.g., tower design) and information (e.g., data) received from the meta node 161, the position node 162, the anemometer 163, the displacement sensor 164, and the one or more load cells 165 to perform a load analysis of the tower 110 (e.g., a TLA). This load analysis includes creating a computer model of the tower 110 with the various equipment, including the equipment 120 and components of the tower load system 150 mounted thereon. In other words, the computer system 166 is able to create a digital twin of the actual tower 110. The computer system 166 uses the computer model to calculate (e.g., estimate) the load being experienced by the tower 110 based on the current tower displacement measured by the displacement sensor 164 and the current wind conditions measured by the anemometer 163. For example, the data obtained from the one or more load cells 165 distributed at various points along the tower 110 can be used to model the load experienced by the tower 110, such as being used to model individual tower members 111. The computer system 166 may use finite element analysis to create the model and to adjust the model based on the incoming information from the anemometer 163, the displacement sensor 164, and the one or more load cells 165. Thus, the computer system 166 can be used to monitor the tower load in real time and generate alerts if the tower load exceeds acceptable thresholds (e.g., thresholds approaching tower failure or collapse). For example, the computer system 166 can alert the NOC if the tower 110 is in danger of collapse due to high wind speeds, by becoming overloaded (e.g., due to a buildup of ice on the tower 110), or due to the current tower displacement.

The computer system 166 can also use the computer model to perform a TLA. This TLA can include determining the remaining load capacity of the tower 110. The load capacity is the amount of load that the tower 110 can bear within the acceptable design limit, which may be influenced by regulations enforced by the relevant regulatory authority. In other words, the load capacity is a design baseline of how much equipment 120 can be placed on the tower 110. The remaining load capacity can be expressed as a percentage of the load capacity.

The remaining load capacity can be evaluated by the NOC, for example, to determine if the tower 110 can accommodate additional equipment 120, and if so, in which positions on the tower 110. Additionally, the computer system 166 can use the information from the one or more status sensors 168 to determine how much of the load capacity (e.g., percentage of the load capacity) is occupied by inactive pieces of equipment 120. The inactive equipment 120, once identified, may be brought back into active service or removed to make room for an additional piece of equipment 120 to efficiently utilize the load capacity of the tower 110. Thus, the computer system 166 can be used to determine the remaining load capacity that would be available if the inactive equipment 120 was removed.

For example, consumer demand for cellular service may have increased in a city which leads to telecommunications companies seeking to fill the demand by adding additional telecommunications equipment to one or more towers, such as tower 110, around the city. The NOC may use the computer system 166 to determine if the tower 110 has available load capacity to handle all or a portion of the additional equipment 120. The computer system 166 can also identify how much of the load capacity is occupied by inactive equipment 120. In some embodiments, the inactive equipment 120 can be reviewed to determine if some pieces of the inactive equipment 120 can be brought back into service to meet the demand rather than adding one or more pieces of additional equipment on the tower 110. In some cases, the inactive equipment 120 can be removed to make room for the additional pieces of equipment 120. The NOC can use the load capacity information about the tower 110 to decide if additional equipment 120 can be added to the tower 110 and/or if inactive pieces of equipment 120 should be removed from the tower 110 to make room for the additional equipment 120.

Additionally, the NOC may use multiple computer systems 166 associated with different towers 110 to identify which towers 110 in a network of towers have available load capacity for additional equipment 120, such as having inactive equipment 120 that could be brought online or removed to make room for additional equipment 120. In some embodiments, the computer system 166 may be connected to multiple towers 110 such that the computer system 166 can assess the load capacity of multiple towers 110 in a network of towers 110, including monitoring multiple towers 110 at the same time.

The TLA performed by the computer system 166 can also include evaluating whether or not the additional equipment 120 can be safely placed on the tower 110, such as determining if the weight and position of the additional equipment 120 would cause the tower to exceed design or regulatory thresholds. This analysis may be performed prior to or immediately after mounting additional equipment 120 on the tower 110. For example, when there is a demand for additional equipment 120, prior to the mounting of additional equipment 120 on the tower 110, the mechanical data for the additional equipment 120 may be provided to the computer system 166. The computer system 166 can use real-time data from the displacement sensor 164, the one or more load cells 165, etc. to simulate the tower 110 with the additional equipment 120 thereon. The simulation may be used to determine if the additional equipment 120 can safely be placed on the tower 110.

As another example, immediately after mounting the additional equipment 120 on the tower 110, the computer system 166 can perform a verification TLA to determine if the additional equipment 120 can remain safely on the tower. For example, the verification TLA may be based on actual measurements taken on the tower 110 by the displacement sensor 164, the one or more load cells 165, etc. with the additional equipment 120 installed. The verification TLA may then be compared to an existing load analysis to verify if mounting of the additional equipment 120 had the predicted effect. An alarm may be triggered if the tower 110 has reached its maximum load capacity, or if the maximum load capacity has not been reached, and the computer system 166 may properly update the available load capacity of the tower 110.

The computer system 166 can also be used to evaluate which locations on the tower 110 that the equipment 120 should be placed. Additionally, the computer model can be used to simulate the performance of the tower 110 with the additional equipment 120 mounted thereto when subjected to various wind loads or shear loads (e.g., earthquakes) when evaluating if the additional equipment 120 can be safely placed on the tower 110.

If the additional equipment 120 is mounted on the tower 110, then the equipment inventory on the tower 110 is updated. Updating the inventory includes updating the information on the meta node 161 and the position node 162. For example, the meta node 161 and the position node 162 may be replaced with a new ROM having the updated mechanical information and positional information of the equipment 120 presently mounted to the tower 110 stored thereon.

The computer system 166 can also use the computer-generated tower model and real time input from the anemometer 163, the displacement sensor 164, and the one or more load cells 165 to identify if one or more tower members 111 are at risk of failure. In some cases, the tower member 111 may begin to fail due to corrosion or due to an unacceptable load. The computer system 166 can use the model to identify potentially failing tower members 111 and their location on the tower 110. These potentially failing tower members 111 are candidates for evaluation by physical inspection, such as by a trained engineer. The computer system 166 can alert the NOC of the presence of these one or more candidates. The NOC can then dispatch qualified personnel to physically inspect the tower members 111 on the tower 110. Thus, the computer system 166 can be used to mitigate structural issues of the tower 110 by identifying structural problems before they become serious.

The computer system 166 reduces the time and cost consumed with engineering assessments of the tower 110. Ordinarily, an engineer would have to perform the TLA based on a physical inspection of the tower 110 to ascertain if additional equipment 120 could be added to the tower 110. Conventional engineering assessments are time consuming and typically are done tower by tower to find the space available to add additional equipment 120 to meet demand. The computer system 166, however, can perform this analysis at a lower cost using data inputs from the tower load system 150 coupled to the tower 110 to identify if the tower 110 has sufficient remaining load capacity and determine if additional equipment 120 can be safely added to the tower 110.

In some embodiments, the TLA performed by the computer system 166 can be used in addition to actual engineering assessments to increase the efficiency of conventional engineering assessments. For example, the computer system 166 can identify if one or more towers 110 in a network of towers potentially has remaining load capacity that could meet the demand of adding additional pieces of equipment 120. The computer system 166 could even determine if the identified tower(s) 110 could have the additional equipment 120 safely mounted thereon, such as generating a plan for where certain additional equipment 120 can be positioned located on a tower 110. Qualified personnel, such as engineers, could then verify the analysis of these towers 110 to confirm that the equipment 120 can be safely added. Additionally, the plan for where the additional equipment 120 could be placed generated by the computer system 166 could be used as a starting point by the engineers and can be adjusted based on the analysis performed by the engineers.

The results of the TLA performed by the computer system 166, such as the real-time monitoring or determination of remaining available load capacity, can be displayed on a computer screen, such as a dashboard at the NOC. In some embodiments, the model may be displayed on the dashboard to show the loading being experienced by the tower 110 or to show the optimal or acceptable locations to add the additional equipment 120.

The computer system 166 can also be used to monitor the health of various pieces of equipment 120 mounted on the tower 110. The computer system 166 can send an alert to the NOC when a failure has occurred or is likely. For example, the aviation light on the tower 110 may be monitored by a health sensor 167. The NOC can be alerted to a failing or failed aviation light based on the data received from the health sensor 167.

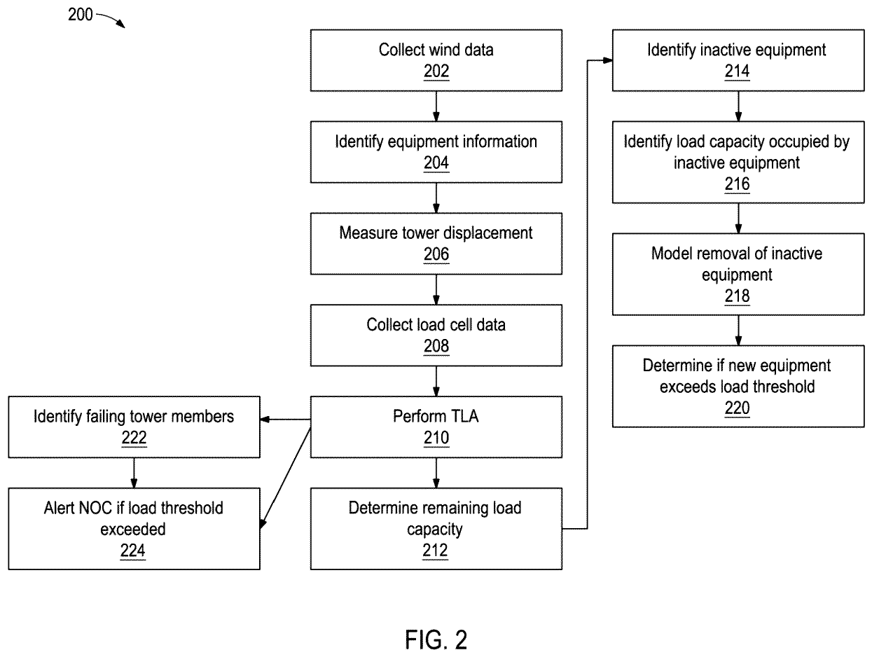

FIG. 2 illustrates an example method of performing a TLA 200 performed by the computer system 166. At operation 202, wind data is collected using the anemometer 163 mounted on the tower 110. At operation 204, the computer system 166 identifies the weight and position of one or more pieces of equipment 120 mounted on the tower 110, such as pulling the weight information from the meta node 161 and the position information from the position node 162. At operation 206, the displacement of the tower 110 is measured using the displacement sensor 164. At operation 208, data is collected from the one or more load cells 165 mounted to the tower 110. At operation 210, the computer system 166 performs a TLA based on the weight and position of the equipment 120, the collected wind data, the measured displacement, and the load measured by each of the one or more load cells 165. For example, the data input into the computer system 166 can be used to construct or update a model of the tower 110 that can be used to evaluate the estimated remaining load capacity of the tower 110. At operation 212, the computer system 166 determines the available remaining load capacity on the tower 110 for additional equipment 120. At operation 214, more pieces of inactive equipment 120 presently mounted to the tower 110 are identified using the one or more status sensors 168. At operation 216, the load capacity of the tower 110 occupied by inactive equipment 120 is identified. Operation 218, which proceeds after operation 216, includes modeling the removal of the inactive equipment 120 from the tower 110 and adding additional equipment 120 to the tower 110 at one or more positions on the tower 110. Operation 220, which proceeds after operation 218, includes determining if the addition of the additional equipment 120 exceeds a load threshold of the tower 110.

In some embodiments, method 200 may include additional operations. For example, at operation 222, one or more candidates for a defective or failing tower member 111 may be identified based on the TLA performed during operation 210. At operation 224, the computer system 166 may send an alert to the NOC if the tower load determined by the TLA performed at operation 210 exceeds a load threshold for the tower 110. The load threshold may be the maximum amount of equipment 120 that can be mounted to the tower 110 based on the design of the tower 110. In other words, the load threshold may be the maximum load capacity of the tower 110.

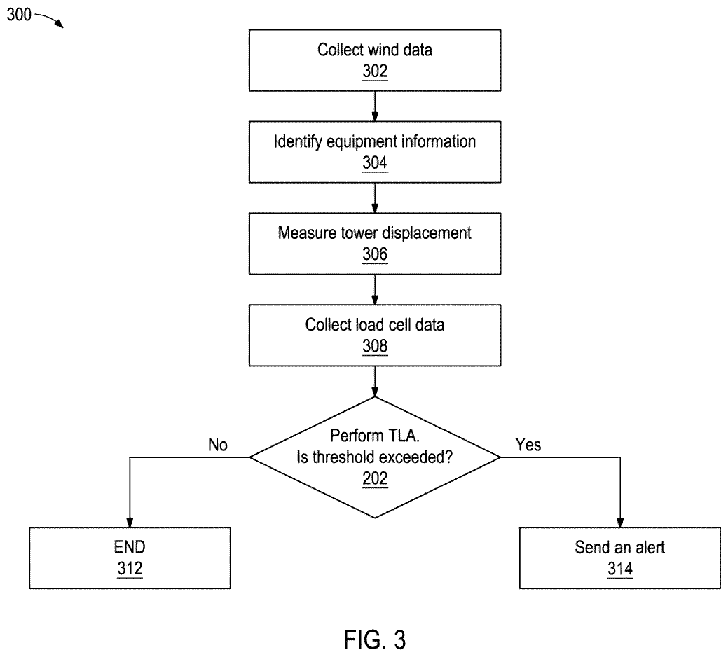

FIG. 3 illustrates an exemplary method 300 of periodically monitoring the tower 110. At operation 302, wind data is collected using the anemometer 163 mounted on the tower 110. At operation 304, the computer system 166 identifies the weight and position of one or more pieces of equipment 120 mounted on the tower 110, such as pulling the weight information from the meta node 161 and the position information from the position node 162. At operation 306, the displacement of the tower 110 is measured using the displacement sensor 164. At operation 308, data is collected from the one or more load cells 165 mounted to the tower 110. At operation 310, the computer system 166 performs a TLA based on the weight and position of the equipment 120, the collected wind data, the measured displacement, and the load measured by each of the one or more load cells 165. After performing operation 310, the computer system 166 determines if the TLA shows that the tower load exceeds a load threshold. If the load threshold is not exceeded, then the computer system 166 does not send an alert to the NOC (step 312). If the TLA shows that the tower load exceeds the load threshold, then operation 314 will commence. At operation 314, the computer system 166 sends an alert to the NOC indicating that the load threshold has been exceeded.

In some embodiments, the method 300 is occurring in real time. In other words, method 300 may repeat constantly until the load analysis shows that the load threshold has been exceeded. For example, an ice storm can occur causing heavy winds, and ice to build up on the tower 110, and the equipment 120. The computer system 166 during the ice storm will be able to (1) collect the current wind data, displacement data, and load data, (2) perform a TLA, and (3) send an alert if the tower load threshold on the tower 110 has been exceeded.

In some embodiments, the computer system 166 may generate an alert if the displacement of the tower 110 exceeds a threshold, such as approaching a displacement that can result in the tower 110 falling over.

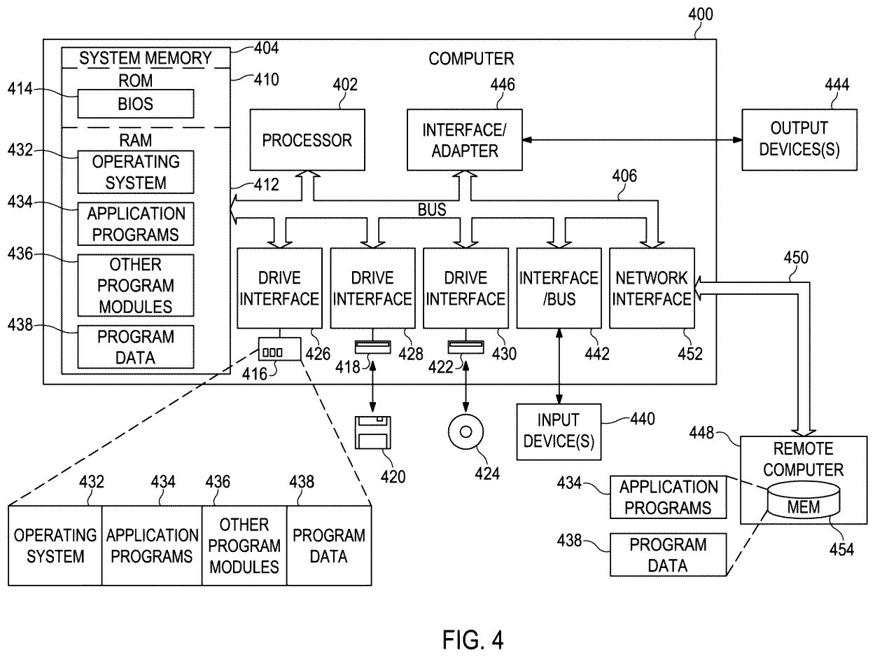

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system 166. An exemplary embodiment of the computer system 166 is shown in FIG. 4. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other integrated circuit (IC) (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 4 illustrates one example of a computer system 400 that can be employed to execute one or more embodiments of the present disclosure. Computer system 400 can be implemented on one or more general purpose networked computer systems, embedded computer systems, routers, switches, server devices, client devices, various intermediate devices/nodes or standalone computer systems. Additionally, computer system 400 can be implemented on various mobile clients such as, for example, a personal digital assistant (PDA), laptop computer, pager, and the like, provided it includes sufficient processing capabilities.

Computer system 400 includes processing unit 402, system memory 404, and system bus 406 that couples various system components, including the system memory 404, to processing unit 402. Dual microprocessors and other multi-processor architectures also can be used as processing unit 402. System bus 406 may be any of several types of bus structure including a memory bus or memory controller, a peripheral bus, and a local bus using any of a variety of bus architectures. System memory 404 includes read only memory (ROM) 410 and random access memory (RAM) 412. A basic input/output system (BIOS) 414 can reside in ROM 410 containing the basic routines that help to transfer information among elements within computer system 400.

Computer system 400 can include a hard disk drive 416, magnetic disk drive 418, e.g., to read from or write to removable disk 420, and an optical disk drive 422, e.g., for reading CD-ROM disk 424 or to read from or write to other optical media. Hard disk drive 416, magnetic disk drive 418, and optical disk drive 422 are connected to system bus 406 by a hard disk drive interface 426, a magnetic disk drive interface 428, and an optical drive interface 430, respectively. The drives and associated computer-readable media provide nonvolatile storage of data, data structures, and computer-executable instructions for computer system 400. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 412, including operating system 432, one or more application programs 434, other program modules 436, and program data 438. In some examples, the program data 438 can include information received from the meta node 161, the position node 162, the anemometer 163, the displacement sensor 164, the one or more load cells 165, the health sensor 167, and the one or more status sensors 168. The application programs 434 and the program data 438 can include functions and methods programmed to perform a TLA. The TLA can be used to facilitate real time monitoring of the tower 110. The TLA can also determine the remaining load capacity of the tower 110, determine a portion of the load capacity occupied by inactive equipment 120, identify one or more candidates for a defective or failing tower member 111, send an alert to the NOC if the tower loading exceeds a load threshold. The TLA may also include modeling adding additional equipment 120 to the tower 110 at one or more positions to determine if adding the additional equipment 120 exceeds the load capacity threshold (e.g., maximum load capacity) for the tower 110. The TLA may also include modelling the removal of the inactive equipment 120 and adding additional equipment 120 to the tower 110 at one or more positions to determine if adding the additional equipment 120 exceeds the load capacity threshold of the tower 110.

A user may enter commands and information into computer system 400 through one or more input devices 440, such as a pointing device (e.g., a mouse, touch screen), keyboard, microphone, joystick, game pad, scanner, and the like. For instance, the one or more input devices 440 may be used to change the position of the new equipment 120 placed on the tower 110 to evaluate if the tower 110 can accommodate the load of the new equipment 120 at that position. These and other input devices 440 are often connected to processing unit 402 through a corresponding port interface 442 that is coupled to the system bus, but may be connected by other interfaces, such as a parallel port, serial port, or universal serial bus (USB). One or more output devices 444 (e.g., display, a monitor, printer, projector, or other type of displaying device) is also connected to system bus 406 via interface 446, such as a video adapter.

Computer system 400 may operate in a networked environment using logical connections to one or more remote computers, such as remote computer 448. Remote computer 448 may be a workstation, computer system, router, peer device, or other common network node, and typically includes many or all the elements described relative to computer system 400. The logical connections, schematically indicated at 450, can include a local area network (LAN) and a wide area network (WAN). When used in a LAN networking environment, computer system 400 can be connected to the local network through a network interface or adapter 452. When used in a WAN networking environment, computer system 400 can include a modem, or can be connected to a communications server on the LAN. The modem, which may be internal or external, can be connected to system bus 406 via an appropriate port interface. In a networked environment, the application programs 434 or the program data 438 depicted relative to computer system 400, or portions thereof, may be stored in a remote memory storage device 454.

According to an embodiment consistent with the present disclosure, the computer system 166 includes a computer readable medium having instructions stored thereon. When the instructions are executed a first method is performed. The method includes performing a TLA. The TLA is performed using the mechanical information of the pieces of equipment 120, the position of the pieces of equipment 120, the measured wind speed, the displacement of the tower 110, and the load measured by each of the one or more load cells 165. The method further includes determining an available load capacity on the tower 110 for the additional pieces of equipment 120 to be mounted to the tower 110 based on the TLA. The available load capacity may be a percentage of available capacity remaining on the tower 110. The method may include creating a tower model and performing a second TLA on the tower model to determine if the tower model is within a load threshold. The tower model may include the tower 110, the pieces of equipment 120 mounted on the tower 110, and the additional pieces of equipment 120. The tower model is configured to allow for organizing the pieces of equipment 120 and the additional pieces of equipment 120 on different parts of the tower 110 in the tower model. The second TLA considers the additional pieces of equipment 120 to be mounted on the tower as pieces of equipment 120 mounted on the tower 110. The second tower analysis uses the mechanical information of the pieces of equipment 120, the position of the pieces of equipment 120, the measured wind speed, the displacement of the tower 110, and the load measured by each of the one or more load cells 165. The method may include identifying available space on the tower 110 for new equipment to be mounted on the tower 110. The method may include identifying one or more candidates for a detective or failing tower member 111 based on the TLA. The method may include sending an alert to the NOC if the tower load exceeds a load threshold. The tower model may include the tower 110, the pieces of equipment 120 mounted on the tower, and the additional pieces of equipment 120. The tower model is configured to allow for organizing the pieces of equipment 120 and the additional pieces of equipment 120 on different parts of the tower 110 in the tower model.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A tower load system, comprising:
a meta node having mechanical information of pieces of equipment mounted on a tower stored thereon, the tower being formed from one or more tower members;
a position node having position information of the pieces of equipment stored thereon;
an anemometer positioned on the tower and configured to measure wind speed and direction;
a displacement sensor configured to determine a displacement of the tower relative to a first position;
one or more load cells coupled to the tower, wherein each of the one or more load cells measures a load; and
a computer system including a computer readable medium having instructions stored thereon, that when executed by a processor, cause a method to be performed, the method comprising:
performing a tower load analysis based on the mechanical information of the pieces of equipment, the position of the pieces of the equipment, the measured wind speed, the displacement of the tower, and the load measured by each of the one or more load cells; and
determining an available load capacity on the tower for additional pieces of equipment to be mounted to the tower based on the tower load analysis.

2. The tower load system of claim 1, further comprising at least one status sensor in communication with the computer system and configured to detect whether or not one or more pieces of equipment on the tower are active or inactive.

3. The tower load system of claim 2, wherein the method further comprises determining the capacity of the tower occupied by inactive equipment based on the at least one status sensor.

4. The tower load system of claim 2, wherein each status sensor is an electromagnetic sensor coupled to a cable leading to one or more pieces of equipment mounted on the tower.

5. The tower load system of claim 1, further comprising a health sensor configured to monitor the health and performance of an aviation light, wherein the aviation light is one of the pieces of equipment mounted on the tower.

6. The tower load system of claim 1, wherein the method further comprises identifying one or more candidates for a defective or failing tower member based on the tower load analysis.

7. The tower load system of claim 1, wherein the mechanical information includes weight and dimensions of each piece of equipment.

8. The tower load system of claim 1, wherein the method further comprises sending an alert to a network operations center if the tower load exceeds a load threshold based on the performed tower load analysis.

9. A method of performing a tower load analysis, comprising:
collecting wind data from an anemometer mounted on a tower;
identifying weight and position of one or more pieces of telecom equipment mounted on the tower;
measuring a displacement of the tower using a displacement sensor mounted to the tower;
collecting load data from one or more load cells mounted to the tower;
performing a tower load analysis based on the weight and position of each piece of telecom equipment, the collected wind data, the measured displacement, and the load measured by each of the one or more load cells; and
determining an available load capacity on the tower for additional pieces of telecom equipment to be mounted to the tower based on the tower load analysis.

10. The method of claim 9, further comprising alerting a network operations center if the tower load determined by the tower load analysis exceeds a load threshold for the tower.

11. The method of claim 9, further comprising identifying one or more pieces of inactive equipment mounted to the tower using at least one status sensor.

12. The method of claim 11, further comprising determining the load capacity of the tower occupied by inactive equipment.

13. The method of claim 12, further comprising:
modeling removing the inactive equipment and adding additional equipment to the tower at one or more positions on the tower; and
modeling if the addition of the additional equipment exceeds a load capacity threshold of the tower after modeling the removal of the inactive equipment.

14. The method of claim 13, further comprising mounting the additional equipment to the tower if the load capacity of the tower is not exceeded.

15. The method of claim 9, further comprising identifying one or more candidates for a defective or failing tower member based on the tower load analysis.
